(19) United States
(12) Patent Application Publication
(10) Pub. No.: US 2016/0034252 A1
(43) Pub. Date: Feb. 4, 2016

(54) SMART DEVICE CONTROL

(71) Applicant: International Business Machines Corporation, Armonk, NY (US)

(72) Inventor: Alexandre Chabrol, Clapiers (FR)

(21) Appl. No.: 14/803,782

(22) Filed: Jul. 20, 2015

(30) Foreign Application Priority Data
Jul. 31, 2014 (GB) 1413619.6

(51) Int. Cl. G06F 3/16; G10L 25/78; G10L 17/22; G02B 27/01; H04N 5/232

(52) U.S. Cl. CPC G06F 3/167; G02B 27/017; H04N 5/23216; G10L 17/22; G10L 25/78; G02B 2027/0178

(57) ABSTRACT

A wearable device such as a head-mountable device and related method are disclosed. The disclosed device includes a processor adapted to respond to a user instruction and to perform an operation in response to said instruction, wherein the processor is adapted to communicate with a microphone adapted to capture sounds from the oral cavity of the user; wherein the processor is adapted to recognize a non-vocal sound generated by the user in said oral cavity as said user instruction.

### FIELD OF THE INVENTION

The present invention relates to the control of a smart wearable device, e.g. a head-mountable device such as smart glasses.

The present invention further relates to a method of controlling a smart wearable device such as smart glasses.

### BACKGROUND

Modern society is becoming more and more reliant on electronic devices to enhance our ways of life. In particular, the advent of portable and wearable electronic devices, as for instance facilitated by the miniaturization of semiconductor components, has greatly increased the role of such devices in modern life. Such electronic devices may be used for information provisioning as well as for interacting with users (wearers) of other electronic devices.

For instance, wearable electronic devices such as head-mountable devices may include a plethora of functionality, such as display functionality that will allow a user of the device to receive desired information on the electronic device, for instance via a wireless connection such as a wireless Internet or phone connection, and/or image capturing functionality for capturing still images, i.e. photos, or image streams, i.e. video, using the wearable electronic device. For example, a head-mountable device such as glasses, headwear and so on, may include image sensing elements capable of capturing such images in response to the appropriate user interaction with the device.

Several different methods of controlling such wearable devices, e.g. head-mountable devices, are known. For instance, US 2013/0257709 A1 discloses a head-mountable device including a proximity sensor at a side section thereof for detecting a particular eye movement, which eye movement can be used to trigger the performance of a computing action by the head-mountable device. US 2013/0258089 A1 discloses a gaze detection technology for controlling an eye camera for instance in the form of glasses. The detected gaze may be used to zoom the camera in on a gaze target. U.S. Pat. No. 8,203,502 B1 discloses a wearable heads-up display with an integrated finger tracking input sensor adapted to recognize finger inputs, e.g. gestures, and use these inputs as commands. It is furthermore known to control such devices using voice commands Each of the above references are incorporated by reference.

A drawback of these control mechanisms is that it requires a discrete and considered action by the wearer of the device. This can cause one or more of the following problems. For example, if the device operation to be triggered by the action of the wearer is time-critical, the time the wearer requires to remember and perform the required action may cause the device operation to be triggered too late. For instance, this problem may occur if the device operation is an image capture of a moving target.

In addition, is the device operation is such an image capture, the performance of such an action may cause the wearer of a head-mountable device to move his or her head, which also may be undesirable in relation to the task to be performed by the head-mountable device, e.g. an image capture event.

Moreover, users may be uncomfortable performing the required actions because the actions may lack discretion. This may prevent a user from performing a desired action or even prevent a user from purchasing such a head-mountable device. In addition, voice recognition control typically requires the accurate positioning of a microphone in or near the mouth of a user, which may be unpleasant and/or may lead to poor recognition if the microphone is not correctly positioned.

### BRIEF SUMMARY OF THE INVENTION

The present invention seeks to provide a smart wearable device such as a head-mountable device that can be more easily controlled.

The present invention further seeks to provide a method for controlling a smart wearable device such as a head-mountable device more easily.

According to an aspect, there is provided a wearable device comprising a processor adapted to respond to a user instruction and to perform an operation in response to said instruction, wherein the processor is adapted to communicate with a microphone adapted to capture sounds from the oral cavity of the user; wherein the processor is adapted to recognize a non-vocal sound generated by the user in said oral cavity as said user instruction.

The present invention is based on the insight that a wearer of a wearable device such as a head-mountable device may control the device by forming sounds in his or her oral cavity (inside his or her mouth), for instance by using saliva present in the oral cavity to generate the sound or noise, e.g. a swallowing noise or a noise generated by displacing saliva inside the oral cavity, such as sucking saliva through teeth or in between tongue and palette for instance, or by using the breathing airflow to generate such noises, e.g. by puffing a cheek or similar. This has the advantage that the operation to be performed by the head-mountable device can be controlled in an intuitive and discrete manner without requiring external or visual movement. Moreover, it has been found that such non-vocal sounds can be recognized more easily than for instance spoken word, such that the positioning of the microphone to detect the non-vocal sounds is less critical, thus increasing device flexibility.

The microphone does not necessarily need to form a part of the wearable device. For instance, a separate microphone may be used that may be connected to the wearable device in any suitable manner, e.g. using a wireless link such as a Bluetooth link. However, in a preferred embodiment, the wearable device further comprises the microphone such that all required hardware elements are contained within the wearable device.

In an embodiment, the wearable device comprises an image sensor under control of said processor; and the processor is adapted to capture an image with said image sensor in response to said instruction. This provides a particularly useful implementation of the present invention, as the discrete and eye or hand movement-free triggering of the image capturing event allows for the accurate capturing of the desired image, or images in case of a video stream, in a discrete manner. The image sensor may form part of a camera module, which module for instance may further comprise optical elements, e.g. one or more lenses, which may be variable lenses, e.g. zoom lenses under control of the processor.

In an embodiment, the wearable device is a head-mountable device.

The head-mountable device comprises glasses in an embodiment. Such smart glasses are particularly suitable for e.g. image capturing, as is well-known per se, for instance from US 2013/0258089 A1. Such glasses may comprise one or more integrated image sensors, for instance integrated in a pair of lenses, at least one of said lenses comprising a plurality of image sensing pixels under control of the processor for capturing an image (or stream of images). Alternatively, one or more image sensors may be integrated in the frame of the glasses, e.g. as part of one or more camera modules as explained above. In an embodiment, a pair of spatially separated image sensors may be capable of capturing individual images, e.g. to compile a 3-D image from the individual images captured by the separate image sensors.

The glasses may comprise a pair of side arms for supporting the glasses on the head, said microphone being positioned at an end of one of said side arms such that the microphone can be positioned behind the ear of the wearer, thereby facilitating the capturing of non-vocal sounds in the oral cavity. Alternatively, the microphone may be attached to said glasses, e.g. using a separate lead, for positioning in or behind an ear of the user.

In an embodiment, the non-vocal sound may be user-programmable such that the wearer of the wearable device can define the sound that should be recognized by the processor of the wearable device, e.g. the head-mountable device. This allows the wearer to define a discrete sound that the wearer is comfortable using to trigger the desired operation of the wearable device, e.g. an image capture operation. To this end, the processor may be adapted to compare a sound captured by the microphone with a programmed sound.

According to another aspect, there is provided a method of controlling a wearable device such as a head-mountable device, including a processor, the method comprising capturing a non-vocal sound generated in the oral cavity of a wearer of the head-mountable device with a microphone; transmitting the captured non-vocal sound to said processor; and performing a device operation with said processor in response to the captured non-vocal sound. Such a method facilitates the operation of a wearable device in a discrete and intuitive manner.

In an embodiment, the method further comprises comparing the captured non-vocal sound to a stored non-vocal sound with said processor; and performing said operation if the captured non-vocal sound matches the stored non-vocal sound to ensure that the desired operation of the wearable device is triggered by the appropriate sound only.

To this end, the method may further comprise recording a non-vocal sound with the microphone; and storing the recorded non-vocal sound to create the stored non-vocal sound. This for instance allows the wearer of the wearable device to define a non-vocal sound-based command the wearer is comfortable using to operate the head-mountable device.

In an example embodiment, the step of performing said operation comprises capturing an image under control of said processor. For instance, said capturing an image may comprise capturing said image using an image sensor integrated in a pair of glasses.

### BRIEF DESCRIPTION OF THE DRAWINGS

Preferred embodiments of the present invention will now be described, by way of example only, with reference to the following drawings, in which:

FIG. 1 schematically depicts a head-mountable device according to an embodiment worn by a user;

FIG. 2 schematically depicts a head-mountable device according to an embodiment;

FIG. 3 schematically depicts a head-mountable device according to another embodiment;

FIG. 4 depicts a flow chart of a method of controlling a head-mountable device according to an embodiment; and

FIG. 5 depicts a flow chart of a method of controlling a head-mountable device according to another embodiment.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

In the context of the present application, where reference is made to a non-vocal sound or noise, this is intended to include any sound formed inside the oral cavity of a person without purposive or primary use of the vocal chords. Such a non-vocal sound may be formed by the displacement of air or saliva within the oral cavity. Non-limiting examples of such non-vocal noises originating within the oral cavity may be a sucking noise, swallowing noise, whistling noise and so on. In some particularly preferred embodiments, the non-vocal noise is a noise involving the displacement of saliva within the oral cavity, i.e. the mouth, for instance by sucking saliva from one location in the oral cavity to another, e.g. sucking saliva through or in between teeth, slurping or swallowing saliva and so on. Such non-vocal sounds may be generated with a closed mouth in some embodiments, thereby allowing the sound to be generated in a discrete manner.

In the context of the present application, a wearable device may be any smart device, e.g. any device comprising electronics for capturing images and/or information over a wireless link that can be worn by a person, for instance around the wrist, neck, waist or on the head of the wearer. For instance, the wearable device may be a head-mountable device, which may be an optical device such as a monocle or a pair of glasses, and/or a garment such as a hat, cap or helmet, which garment may comprise an integrated optical device. Other suitable head-mountable devices will be apparent to the skilled person.

In the remainder of this description, the wearable device and the method of controlling such as device will be described using a head-mountable device by way of non-limiting example only; it should be understood that the wearable device may take any suitable alternative shape, e.g. a smart watch, smart necklace, smart belt and so on.

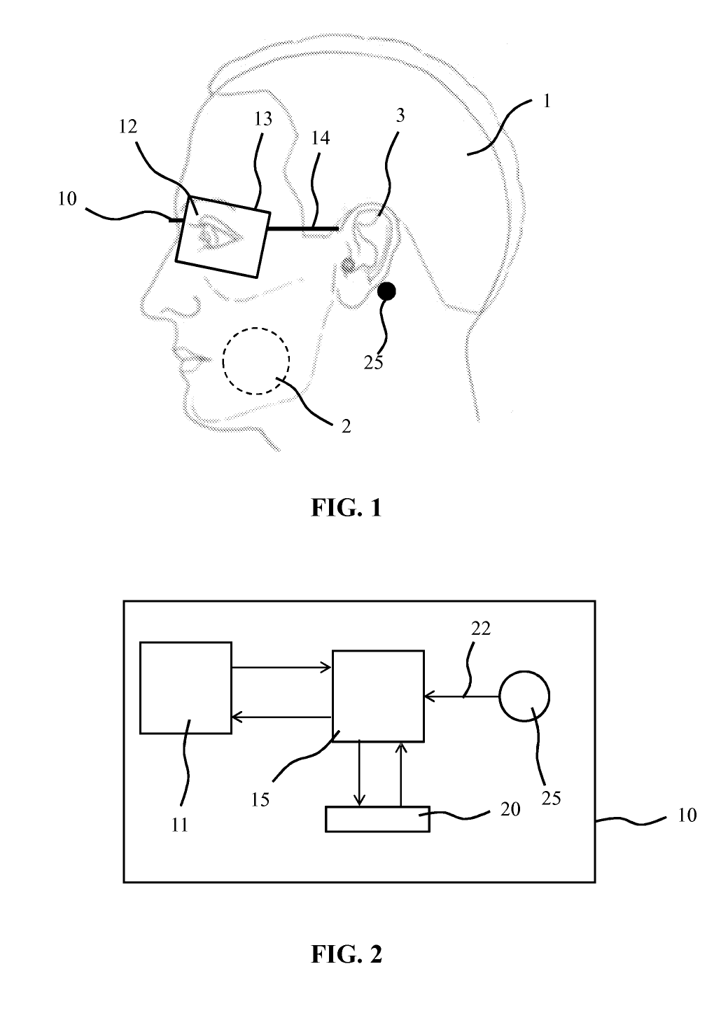

FIG. 1 schematically depicts an example embodiment of such a head-mountable device 10 worn by a wearer 1, here shown in the form of a pair of glasses by way of non-limiting example only. The pair of glasses typically comprises a pair of lenses 12 mounted in a mounting frame 13, with side arms 14 extending from the mounting frame 13 to support the glasses on the ears 3 of the wearer 1, as is well-known per se. The mounting frame 13 and side arms 14 each may be manufactured from any suitable material, e.g. a metal or plastics material, and may be hollow to house wires, the function of which will be explained in more detail below.

FIG. 2 schematically depicts a non-limiting example embodiment of the circuit arrangement included in the head-mountable device 10. By way of non-limiting example, the head-mountable device 10 comprises an optical device 11 communicatively coupled to a processor 15, which processor is arranged to control the optical device 11 in accordance with instructions received from the wearer 1 of the head-mountable device 10. The optical device 11 for instance may be a heads-up display integrated in one or more of the lenses 12 of the head-mountable device 10. In a particularly advantageous embodiment, the optical device 11 may include an image sensor for capturing still images or a stream of images under control of the processor 15. For instance, the optical device 11 may comprise a camera module including such an image sensor, which camera module may further include optical elements such as lenses, e.g. zoom lenses, which may be controlled by the processor 15, as is well-known per se. The head-mountable device 10 may comprise one or more of such optical devices 11, e.g. two image sensors for capturing stereoscopic images, or a combination of a heads-up display with one or more of such image sensors.

The at least one optical device 11 may be integrated in the head-mountable device 10 in any suitable manner. For instance, in case of the at least one optical device 11 being an image sensor, e.g. an image sensor forming part of a camera module, the at least one optical device 11 may be integrated in or placed on the mounting frame 13 or the side arms 14. Alternatively, the at least one optical device 11 may be integrated in or placed on the lenses 12. For instance, at least one of the lenses 12 may comprise a plurality of image sensing pixels and/or display pixels for implementing an image sensor and/or a heads-up display. The integration of such optical functionality in a head-mountable device 10 such as smart glasses is well-known per se to the person skilled in the art and will therefore not be explained in further detail for the sake of brevity only.

Similarly, the processor 15 may be integrated in or on the head-mountable device 10 in any suitable manner and in or on any suitable location. For instance, the processor 15 may be integrated in or on the mounting frame 13, the side arms 14 or the bridge in between the lenses 12. Communicative coupling between the one or more optical devices 11 and the processor 15 may be provided in any suitable manner, e.g. in the form of wires or alternative electrically conductive members integrated or hidden in the support frame 13 and/or side arms 14 of the head-mountable device 10. The processor 15 may be any suitable processor, e.g. a general purpose processor or an application-specific integrated circuit.

The processor 15 is typically arranged to facilitate the smart functionalities of the head-mountable device 10, e.g. to control the one or more optical devices 11, e.g. by capturing data from one or more image sensors and optionally processing this data, by receiving data for display on an heads-up display and driving the display to display the data, and so on. As this is well-known per se to the skilled person, this will not be explained in further detail for the sake of brevity only.

The head-mountable device 10 may further comprise one or more data storage devices 20, e.g. a type of memory such as a RAM memory, Flash memory, solid state memory and so on, communicatively coupled to the processor 15. The processor 15 for instance may store data captured by the one or more optical devices 11 in the one or more data storage devices 20, e.g. store pictures or videos in the one or more data storage devices 20. In an embodiment, the one or more data storage devices 20 may also include computer-readable code that can be read and executed by the processor 15. For instance, the one or more data storage devices 20 may include program code for execution by the processor 15, which program code implements the desired functionality of the head-mountable device 10. The one or more data storage devices 20 may be integrated in the head-mountable device 10 in any suitable manner. In an embodiment, at least some of the data storage devices 20 may be integrated in the processor 15.

The processor 15 is responsive to a microphone 25 for placing in the ear area 3 of the wearer 1 such that the microphone 25 can pick up noises in the oral cavity or mouth 2 of the wearer 1. For instance, the microphone 25 may be shaped such that it can be placed behind the ear 3 as shown in FIG. 1 or alternatively the microphone 25 may be shaped such that it can be placed in the ear 3. Other suitable shapes and locations for the microphone 25 will be apparent to the skilled person.

In FIG. 2, the microphone 25 is shown as an integral part of the head-mountable device 10. For instance, the microphone 25 may be attached to or integrated in a side arm 14 of a head-mountable device 10 in the form of glasses, such that the microphone 25 is positioned behind the ear 3 of the wearer 1 in normal use of the head-mountable device 10. In this embodiment, the microphone 25 may be communicatively connected to the processor 15 by via link 22, which may be embodied by electrically conductive tracks, e.g. wires, embedded in the side arm 14.

Alternatively, the microphone 25 may be connected to the head-mountable device 10 by means of a flexible lead, which allows the wearer 1 to position the microphone 25 at a suitable location such as behind or inside the ear 3. In this embodiment, the microphone 25 may be communicatively connected to the processor 15 via a link 22, such as by electrically conductive tracks, e.g. wires, embedded in the flexible lead.

In yet another embodiment, the microphone 25 may be wirelessly connected to the processor 15 via a wireless link 22. To this end, the microphone 25 includes a wireless transmitter and the head-mountable device 10 includes a wireless receiver communicatively coupled to the processor 15, which wireless transmitter and wireless receiver are arranged to communicate with each other over a wireless link using any suitable wireless communication protocol such as Bluetooth. The wireless receiver may form an integral part of the processor 15 or may be separate to the processor 15.

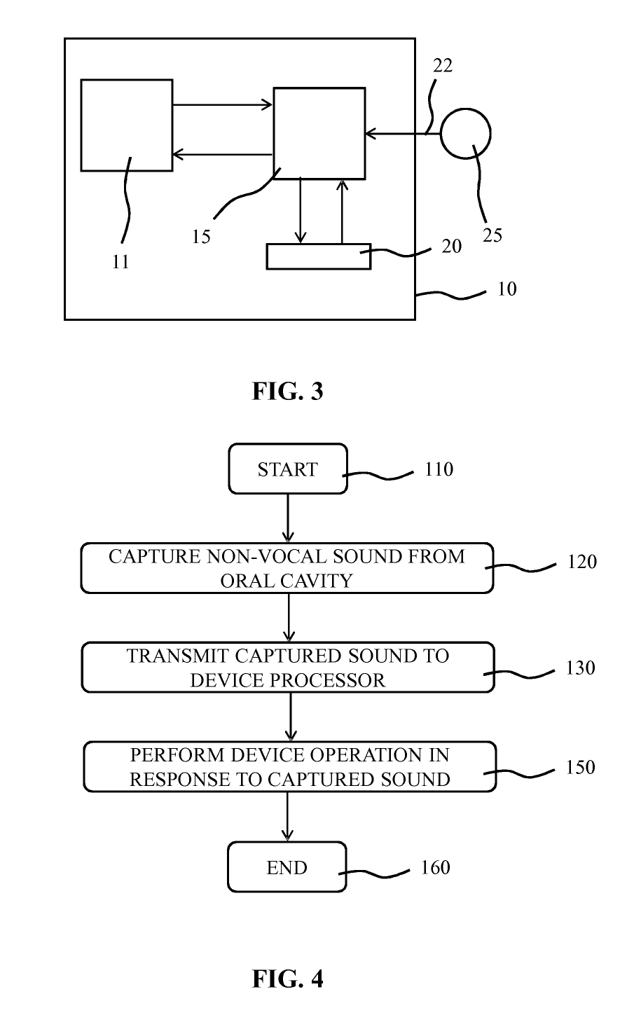

In this wireless embodiment, it is not necessary for the microphone 25 to form an integral part of the head-mountable device 10. The microphone 25 in this embodiment may be provided as a separate component, as schematically shown in FIG. 3 where the microphone 25 is depicted outside the boundary of the head-mountable device 10. It should be understood that it is furthermore feasible to provide a head-mountable device 10 without a microphone 25, wherein a separate microphone 25 may be provided that can communicate with the processor 15 over a wired connection, e.g. by plugging the separate microphone 25 into a communications port such as a (micro) USB port or the like of the head-mountable device 10.

The microphone 25 may communicate the noises captured in the oral cavity 2 of the wearer 1 in digital form to the processor 15. To this end, the microphone 25 may include an analog to digital converter (ADC) that converts a captured analog signal into a digital signal before transmitting a signal to the processor 15. Alternatively, the microphone 25 may be arranged to transmit an analog signal to the head-mountable device 10, in which case the head-mountable device 10, e.g. the processor 15, may include an ADC to perform the necessary conversion.

In operation, the microphone 25 is arranged to communicate with the processor 15 such that the processor 15 may control the head-mountable device 10. This will be explained in more detail with the aid of FIG. 4, which depicts a flow chart of an embodiment of a method of controlling such a head-mountable device 10, which method initiates in step 110.

As mentioned before, the microphone 25 is typically positioned such that it captures noises within the oral cavity 2 of the wearer 1 of the head-mountable device 10. In particular, the microphone 25 may capture non-vocal noises within the oral cavity 2, as shown in step 120. The microphone 25 communicates, i.e. transmits, the detected noises to the processor 15 as shown in step 130. The processor 15 analyses the detected noises received from the microphone 25 to determine if the detected noise is a defined non-vocal sound that should be recognized as a user instruction. To this end, the processor 15 may perform a pattern analysis as is well-known per se. For instance, the processor 15 may compare the received noise with a stored pattern to determine if the received noise matches the stored noise pattern. Upon such a pattern match, the processor 15 will have established that the wearer 1 of the head-mountable device 10 has issued a particular instruction to the head-mountable device 10, such as for instance an instruction to capture an image or a stream of images with the at least one optical device 11, e.g. the at least one image sensor.

For instance, the wearer 1 may have issued an instruction to take a picture or record a video using the head-mountable device 10. Following the recognition of the instruction, i.e. following recognition of the captured non-vocal sound as an instruction, the processor 15 will perform the desired device operation in step 150 before the method terminates in step 160. It will be clear to the skilled person that the performed device operation in step 150 may include additional steps such as the storage of captured image data in the one or more data storage devices 20 and/or the displaying of the captured image data on a heads-up display of the head-mountable device 10.

In an embodiment, the processor 15 may be pre-programmed to recognize a particular non-vocal sound. In this embodiment, the head-mountable device 10 may be programmed to train the wearer 1 in generating the pre-programmed non-vocal sound, e.g. by including a speaker and playing back the noise to the wearer 1 over the speaker. Alternatively, the non-vocal sound may be described in a user manual. Other ways of teaching the wearer 1 to produce the appropriate non-vocal sound may be apparent to the skilled person.

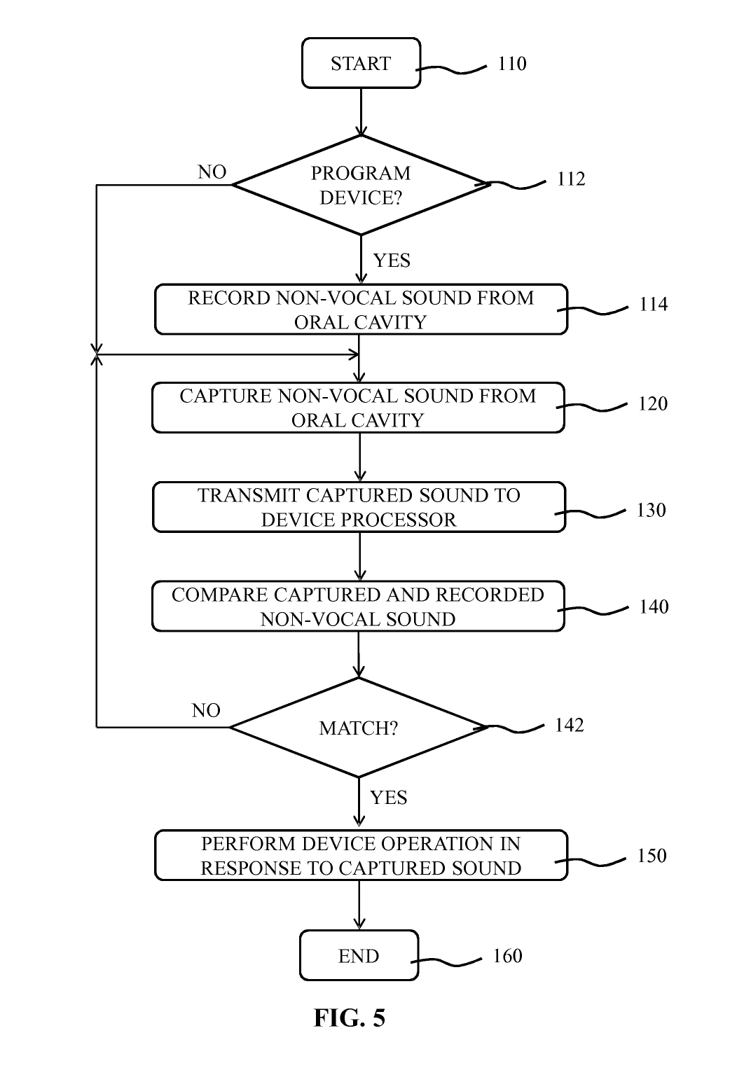

In a particularly advantageous embodiment, the head-mountable device 10 may allow the wearer 1 to define a non-vocal sound of choice to be recognized by the processor 15 as the instruction for performing a particular operation with the head-mountable device 10. The control method in accordance to this embodiment will be explained in further detail with the aid of FIG. 5, which depicts a flow chart of the method according to this embodiment.

As before, the method is initiated in step 110, after which it is checked in step 112 if the wearer 1 wants to program the head-mountable device 10 by providing the head-mountable device 10 with the non-vocal sound of choice. To this end, the head-mountable device 10 may include an additional user interface such as a button or the like to initiate the programming mode of the head-mountable device 10. Alternatively, the processor 15 may further be configured to recognize voice commands received through the microphone 25, such as “PROGRAM INSTRUCTION” or the like.

If it is detected in step 112 that the wearer 1 wants to program the head-mountable device 10, the method proceeds to step 114 in which the user-specified non-vocal sound is captured with the microphone 25 and stored by the processor 15. For instance, the processor 15 may store the recorded user-specified non-vocal sound in the data storage device 20, which may form part of the processor 15 as previously explained. In an embodiment, step 114 is performed upon confirmation of the wearer 1 that the captured non-vocal sound is acceptable, for instance by the wearer 1 confirming that step 114 should be performed by providing the appropriate instruction, e.g. via the aforementioned additional user interface. If the head-mountable device 10 is equipped with a display, the wearer 1 may further be assisted in the recording process by the displaying of appropriate instructions on the display of the head-mountable device 10. In this embodiment, step 112 may be repeated until the wearer 1 has indicated that the captured non-vocal sound should be stored, after which the method proceeds to step 114 as previously explained. This is not explicitly shown in FIG. 5.

Upon completion of the programming mode, or upon the wearer 1 indicating in step 112 that the head-mountable device 10 does not require programming, e.g. by not invoking the programming mode of the head-mountable device 10, the method proceeds to the previously described step 120 in which the microphone 25 captures sounds originating from the oral cavity 2 of the wearer 1 and transmits the captured sounds to the processor 15 in the previously described step 130.

In step 140, the processor 15 compares the captured non-vocal sound with the recorded non-vocal sound of step 114, e.g. using the previously explained pattern matching or other suitable comparison techniques that will be immediately apparent to the skilled person. It is checked in step 142 if the captured sound matches the stored sound, after which the method proceeds to previously described step 150 in which the processor 15 invokes the desired operation on the head-mountable device 10 in case of a match or returns to step 120 in case the captured non-vocal sound does not match the stored non-vocal sound.

At this point, it is noted that the head-mountable device 10 may of course include further functionality, such as a transmitter and/or a receiver for communicating wirelessly with a remote server such as a wireless access point or a mobile telephony access point. In addition, the head-mountable device 10 may comprise additional user interfaces for operating the head-mountable device 10. For example, an additional user interface may be provided in case the head-mountable device 10 includes a heads-up display in addition to an image capturing device, where the image capturing device may be controlled as previously described and the heads-up display may be controlled using the additional user interface. Any suitable user interface may be used for this purpose. The head-mountable device 10 may further comprise a communication port, e.g. a (micro) USB port or a proprietary port for connecting the head-mountable device 10 to an external device, e.g. for the purpose of charging the head-mountable device 10 and/or communicating with the head-mountable device 10. The head-mountable device 10 typically further comprises a power source, e.g. a battery, integrated in the head-mountable device 10.

Moreover, although the concept of the present invention has been explained in particular relation to image capturing using the head-mountable device 10, it should be understood that any type of operation of the head-mountable device 10 may be invoked by the processor 15 upon recognition of a non-vocal sound generated in the oral cavity 2 of the wearer 1.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A wearable device, comprising:
a processor adapted to respond to a user instruction and to perform an operation in response to said instruction, wherein the processor is adapted to communicate with a microphone adapted to capture sounds from the oral cavity of the user;
wherein the processor is adapted to recognize a non-vocal sound generated by the user in said oral cavity as said user instruction.

2. The wearable device of claim 1, further comprising the microphone.

3. The wearable device of claim 2, wherein:
the wearable device comprises an image sensor under control of said processor; and
the processor is adapted to capture an image with said image sensor in response to said instruction.

4. The wearable device of claim 3, wherein the image sensor forms part of a camera.

5. The wearable device of claim 4, wherein the wearable device is a head-mountable device.

6. The wearable device of claim 5, wherein the head-mountable device comprises glasses that comprise a pair of side arms for supporting the glasses on the head of the user, said microphone being positioned at an end of one of said side arms.

7. The wearable device of claim 6, wherein the microphone is attached to said glasses for positioning in or behind an ear of the user.

8. The wearable device of any of claims 1, wherein the processor includes a storage for prerecording user-programmed sounds.

9. The wearable device of claim 8, wherein the processor is adapted to compare a sound captured by the microphone with a user-programmed sound.

10. The wearable device of any of claim 1, wherein the non-vocal sound is generated using one of saliva and by swallowing.

11. A method of controlling a wearable device including a processor comprising:
capturing a non-vocal sound generated in the oral cavity of a wearer of the wearable device using a microphone;
transmitting the captured non-vocal sound to said processor; and
performing a device operation with said processor in response to the captured non-vocal sound.

12. The method of claim 11, further comprising:
comparing the captured non-vocal sound to a stored non-vocal sound with said processor; and
performing said operation if the captured non-vocal sound matches the stored non-vocal sound.

13. The method of claim 12, further comprising:
recording a non-vocal sound with the microphone; and
storing the recorded non-vocal sound to create the stored non-vocal sound.

14. The method of claim 11, wherein the step of performing said device operation comprises capturing an image under control of said processor.

15. The method of claim 14, wherein the wearable device comprises a pair of glasses, and wherein said capturing an image comprises capturing said image using an image sensor embedded in said pair of glasses.

16. A head-mountable device, comprising:
a pair of glasses that includes side arms for supporting the glasses on a head of a user;
a microphone positioned at an end of one of said side arms, wherein the microphone is adapted to capture non-vocal sounds from the oral cavity of the user;
a camera mounted on the glasses; and
a processor adapted to communicate with the microphone and camera, wherein the processor is programmed to analyze a captured non-vocal sound to determine whether the captured non-vocal sound includes an image capture instruction, and wherein the processor is adapted to capture an image using the camera in response to a detected image capture instruction.

17. The head-mountable device of claim 16, wherein the microphone includes an analog to digital converter (ADC) that converts a captured analog signal into a digital signal before transmitting a signal to the processor.

18. The head-mountable device of claim 16, wherein the processor compares the captured non-vocal sound with a set of stored noise patterns.

19. The head-mountable device of claim 16, wherein the glasses include a heads up display.

20. The head-mountable device of claim 19, wherein the heads up display is controllable in response to a second captured non-vocal sound.
